(19) United States
(12) Patent Application Publication
(10) Pub. No.: US 2006/0096169 A1
(43) Pub. Date: May 11, 2006

(54) Plastic landscape border system

(76) Inventor: Jimmy L. Love, West Point, MS (US)

Correspondence Address: LITMAN LAW OFFICES, LTD, PO BOX 15035, CRYSTAL CITY STATION, ARLINGTON, VA, 22215, US

(21) Appl. No.: 11/197,454

(22) Filed: Aug. 5, 2005

Related U.S. Application Data
(60) Provisional application No. 60/622,052, filed on Oct. 27, 2004.

(51) Int. Cl. A01G 23/10

(52) U.S. Cl. 47/10

(57) ABSTRACT

A landscape edging system interlocks to form a landscape timber or tie capable of conforming to contours of a flowerbed or other landscape structure in need of a border. A main body component is hollow and made in the shape of a wood landscape timber or tie. End mountable and replaceable male connector components, female connector components, and three-way connector components are provided to interconnect the main body components to form any desired pattern, including the building of retaining walls. An anchor stake pipe is provided at each connection to serve as and axel around which the main body components are radially adjusted, the stake pipe being driven into the ground as desired to avoid shifting of the system components. The timber or tie is simulated by lightweight tubular plastic.

### CROSS-REFERENCE TO RELATED APPLICATION

This application claims the benefit of U.S. Provisional Patent Application Ser. No. 60/622,052, filed Oct. 27, 2004.

### BACKGROUND OF THE INVENTION

1. Field of the Invention

The present invention relates to landscape edging system. More particularly, the present invention relates to log or tie-like edging systems having rotatable joints.

2. Description of the Related Art

Existing landscape edging is traditionally partially rounded brick set edge to edge to separate one landscape feature from another such as a driveway or flowerbed from a lawn. Other edging systems include vertical, plastic or rubber edging which is held by stakes or are partially buried. It is also common to employ logs or railroad ties or the like as landscape edging. These logs or ties may also be laid on each other to form a low fence or retaining wall. Logs or ties offer attractive, rustic appeal to a lawn or garden but have the deficiencies of substantial weight in handling and deterioration due to rotting or weather.

Such logs or ties are also difficult to connect end-to-end, straight or at an angle to form a desired, overall landscape feature such as a polygonal shape. Some edging systems provide types of end-to-end connections but none provide a light weight system easily installed including both two-way and three-way connections. It would be desirable to provide a landscape edging system having the appearance of logs, ties, or the like which are light in weight for easy handling and assembly, and have end connection features which allow any desired two-way or three-way end joints to build polygonal patterns and retaining walls as desired for attractive landscape features.

None of the above-described known lawn edging systems, taken either singly or in combination, are seen to describe the instant invention as claimed. Thus a landscape edging systems solving the aforementioned problems is desired.

### SUMMARY OF THE INVENTION

The landscape edging system of the present invention provides a plurality of lightweight components that adjustably interlock to form a landscape timber or tie capable of conforming to contours of a flowerbed or other landscape structure in need of a border. A main body component is hollow and made in the shape of a wood landscape timber or tie. End mountable and replaceable male connector components, female connector components and a three-way connector components are provided to interconnect the main body components to form any desired pattern, including the building of retaining walls. An anchor stake pipe is provided at each connection to serve as an axel around which the main body components may be radially adjusted, the stake pipe being driven into the ground as desired to avoid shifting of the system components. The three-way joint feature allows the system to be used as anchor ties for retaining walls.

A cap component mounts to the top of the anchor stake pipe to provide a finished appearance. The system is preferably molded of plastic such as PVC, the main body components being hollow to reduce weight and cost, although other materials such as metal could be employed in their construction. Once installed, the system of the present invention may be easily removed as desired for changes in landscaping.

It is an aspect of the invention that there is provided improved elements and arrangements thereof for the purposes described which is inexpensive, dependable and fully effective in accomplishing its intended purposes.

These and other aspects of the present invention will become readily apparent upon further review of the following specification and drawings.

### BRIEF DESCRIPTION OF THE DRAWINGS

FIG. 1 is an environmental, perspective view of the landscape edging system according to the present invention employing log-shaped edging members forming a polygon.

FIG. 2 is an exploded view of male and female joint members, edging members, and anchor stake pipe of FIG. 1.

FIG. 3 is a plan view of a three-way edging joint and connected edging members.

FIG. 4 is an exploded view of the joint of FIG. 3.

FIG. 5 is a plan view similar to that of FIG. 3, employing square cross section such as simulated railroad ties.

Similar reference characters denote corresponding features consistently throughout the attached drawings.

### DETAILED DESCRIPTION OF THE PREFERRED EMBODIMENT

The present invention is a lightweight edging system for landscaping simulating wooden logs or ties.

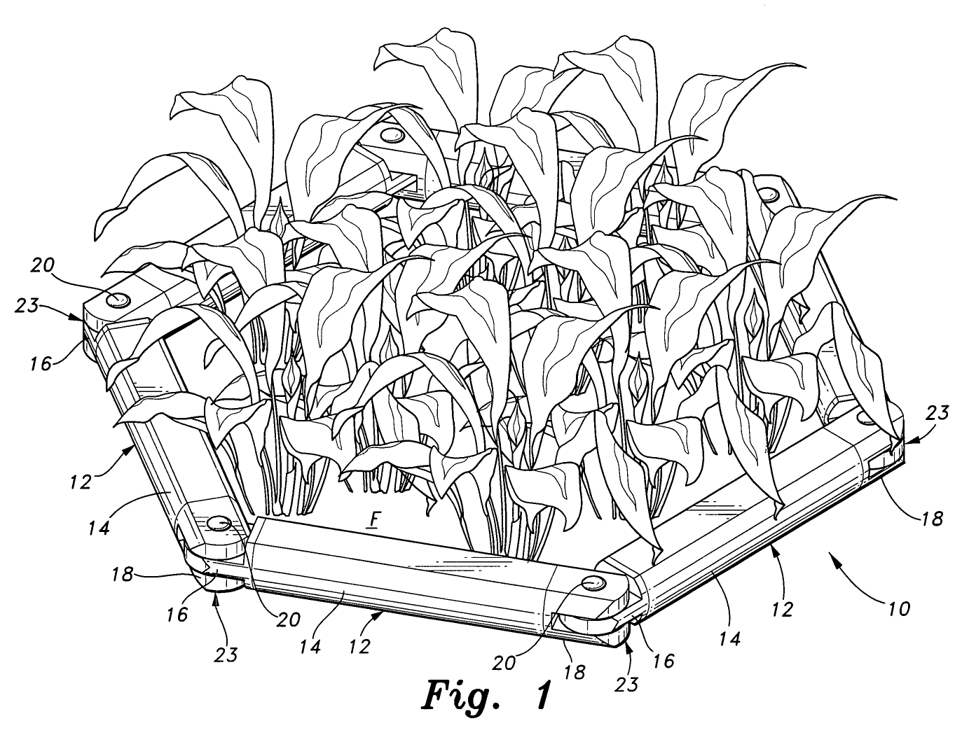

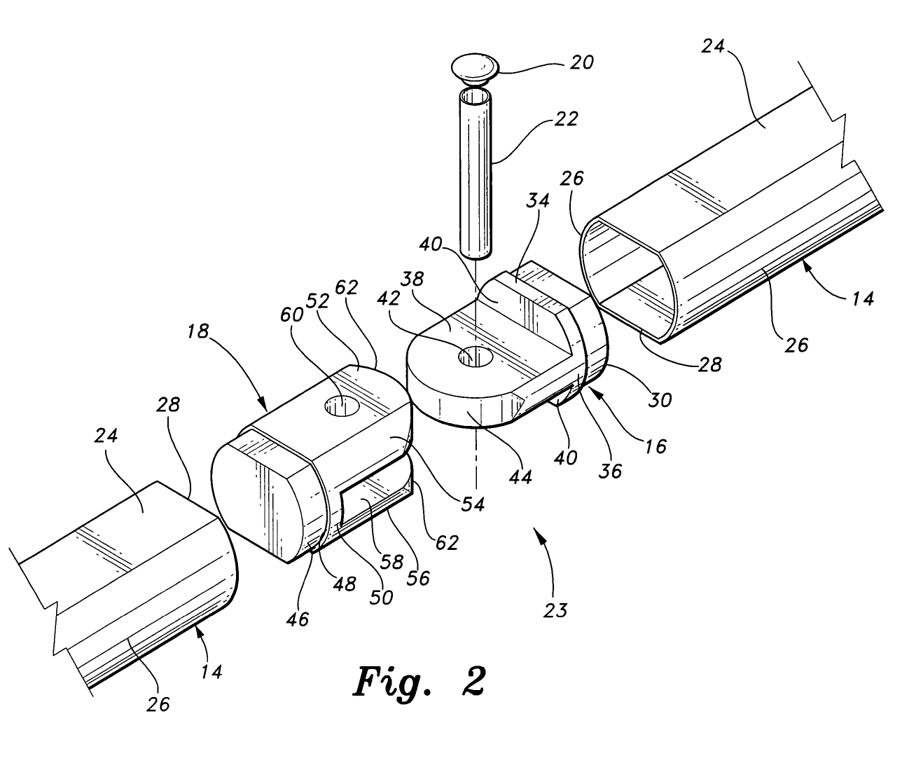

Referring to FIGS. 1 and 2, there are shown an environmental perspective and a detail exploded view of a two-way joint embodiment of the inventive landscape edging system. Landscape edging system 10 is shown surrounding flower bed F and includes log or tie units 12 having tubular main body units 14, each having a male connector 16 and a female connector 18 mounted at respective opposed ends thereof. Succeeding male and female connectors are interconnected in the manner of a hinge by anchor pipe stake 22 acting as an anchor and an axle or pivot pin, the top of which is covered by pipe stake cover 20 and forming successive two-way joints 23.

As best seen in FIG. 2, main body elements 14 have horizontal walls 24 and generally vertical sidewalls 26 having opposing main body ends 28. Male connectors 16 and female connectors 18 are each slideably and frictionally engaged at opposed ends 28 within tubular main body elements 14 by male connector joining portion 30 up to joint jamb 34 and by female connector joining portion 46 up to joint jamb 48. Male connectors 16 each include a male connector base portion 36 from which male connector insert portion 38 laterally extends. Male connector insert portion 38 is generally shaped as a tongue extending perpendicularly from vertical male connector base portion outer walls 40 having a rounded ends 44 and defining a stake receiving bore 42.

Female connectors 18 each include a female connector base portion 50 from which female reception portion 52, including female upper joint portion 54 and female lower joint portion 56 extend defining female receiving groove 58. Female connectors 18 each have rounded ends 62 and define receiving stake receiving bores 60 for alignment with male connector stake receiving bores 42 to form a continuous bore during assembly of the system 10.

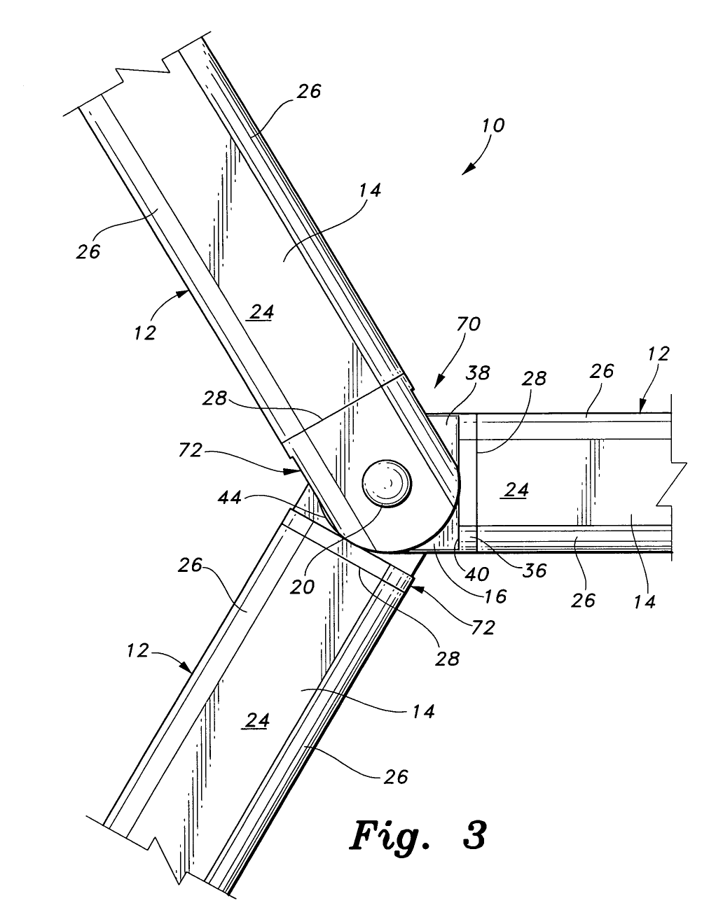

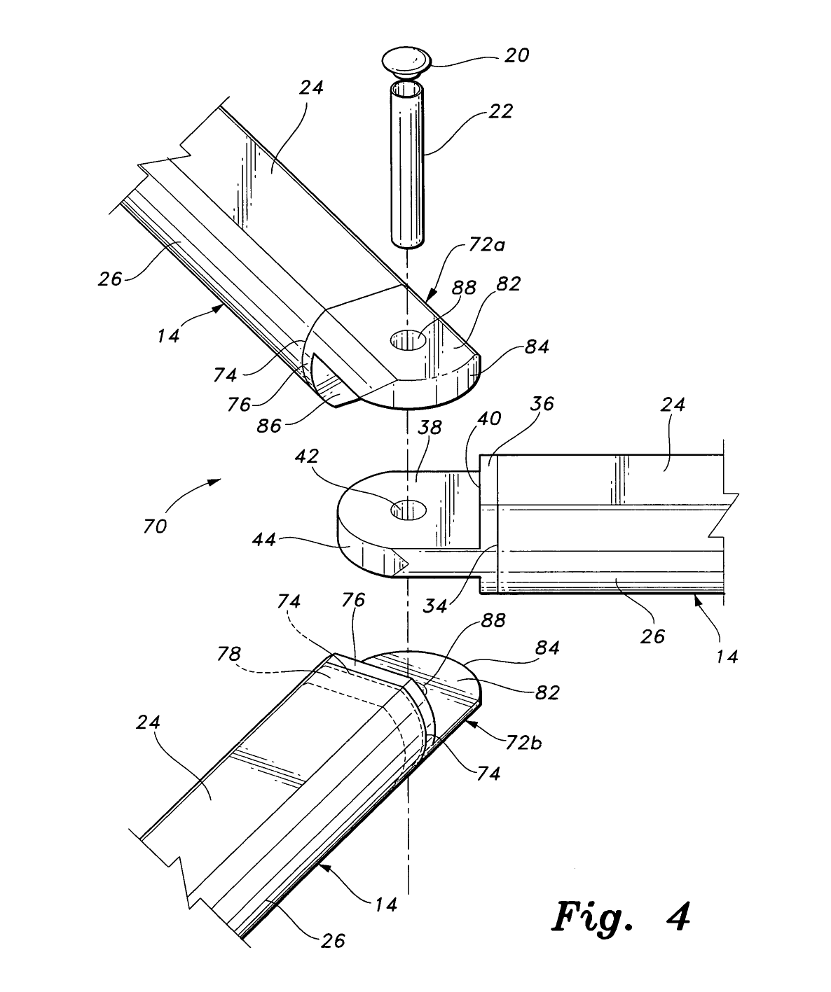

Referring to FIGS. 3 and 4, there are shown a plan view and an exploded view, respectively, of the system 10 employing a three-way joint 70. Three-way joint 70 employs a male connector as described above. Three-way joint 70 employs identical three-way connectors 72a and 72b (see FIG. 4), which are alternatively oriented in an upper position and a lower position relative to log or tie units 12 so as to collectively form a female connection similar to that of female connector 18. Three-way connectors 72 have a three-way connector joint jamb 74 from which extend three-way connector base portions 76.

Three-way connectors 72 each have a joining portion 78 identical to that of female connector joining portion 46. Three-way connector joint portion 82 extends axially outward from base portion 76 having outer wall 86 and has a rounded end 84. Joint portions 82 define stake-receiving bores 88. Upper and lower three-way joint portions 82 form a joint between three tubular main body elements 14 by joining a male connector 16 in a central portion formed by a three-way joint connector 72a in an upper position and a three-way joint connector 72b in a lower position. Joint portion 82 define receiving stake receiving bores 88 for alignment with male connector stake receiving bores 42 to form a continuous bore during assembly of the system 10.

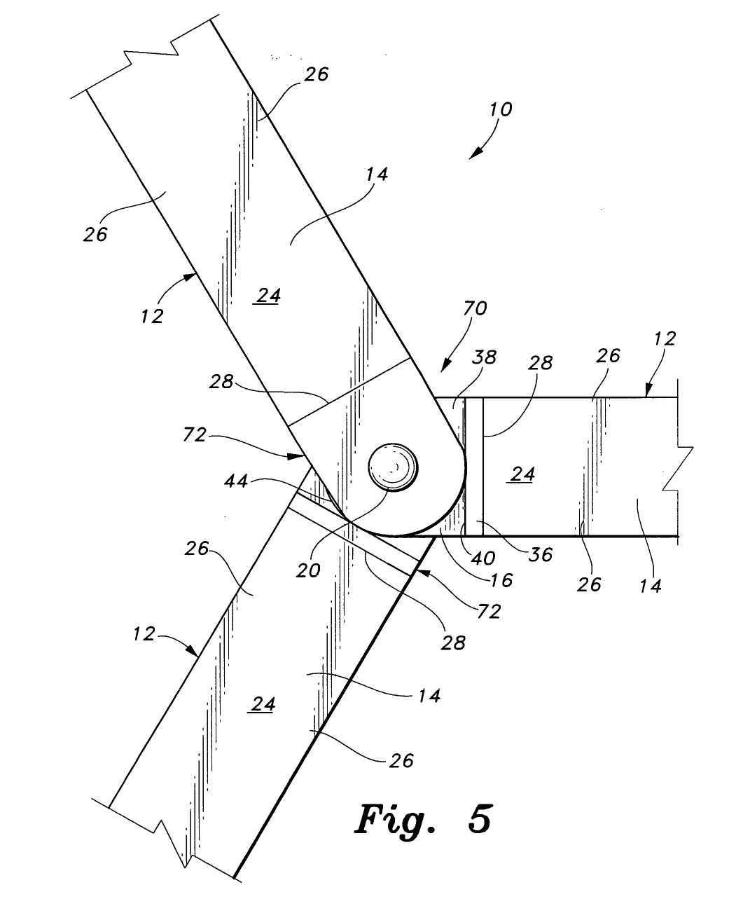

Referring to FIG. 5, there is shown a plan view of a three-way joint 70 of the landscape border system 10 employing a rectangular log or tie element 14 and connectors 16 and 72a and 72b. The main body element 14 also employs a modified female connector 18 (not shown) modified in a similar manner to be received in rectangular cross-section log or tie element 14.

The plan views of FIGS. 3 and 5 may be envisioned as including stacked log or tie elements 14 with multiple male and three-way connectors 16 and 70, employing a lengthened pipe stake 18 under cover 20, wherein one side of the “Y”-shaped structure formed by two tiers of the log or tie units forms a retaining wall for earth or the like and the third side of the structure acts as a supporting strut. The system 10 as shown in a “Y”-shape may be easily be modified to a “T”-shape to form a flat, vertical wall, or any other desired configuration.

The main body elements 14 of the present invention are preferably tubular plastic such as ⅛″ polyvinyl chloride (PVC) but may be made of metal or other suitable material. The male, female, and three-way connectors are preferably made of suitable plastic and may be solid or partially hollow. The stake is preferably of plastic such as PVC pipe, and the stake cap is preferably made of molded plastic material, which is glued on before driving the assembled parts into the ground.

It is to be understood that the present invention is not limited to the embodiments described above, but encompasses any and all embodiments within the scope of the following claims.

I claim:

1. A landscape edging system, comprising:
a plurality of simulated log units comprising:
a plurality of tubular main body elements having opposing sidewalls, upper and lower walls, and opposing ends;
a plurality of male connectors slidingly and frictionally engaging said tubular main body elements at one end thereof;
a plurality of female connectors slidingly and frictionally engaging said tubular main body elements at an opposed end thereof;
each said male connector and said female connector defining a stake-receiving bore;
said stake-receiving bores of said female connectors and said male defining a common stake-receiving bore upon the mating of said female connectors with said male connectors;
a plurality of stakes of such size and length as to be received in said common stake receiving bore upon assembly of said simulated log units and driven into the ground;
said plurality of stakes acting as axles around which pairs of said simulated log units may be rotated so as to obtain a desired edging pattern.

2. The landscape edging system of claim 1, wherein said simulated log units form a closed polygon;

3. The landscape edging system of claim 1, each said male connector having a joining portion ending in a joint jamb so configured and sized as to slidingly engage at least one of said opposed ends of said tubular main body elements;

4. The landscape edging system claim 3, each said male connector having a male connector insert portion extending axially outward from said male connector joining portion.

5. The landscape edging system of claim 4, each said male connector having a base portion connecting said joining portion and said male connector insert portion, said base portion forming said joint jamb and having outer wall portions, said male connector joining portion having a rounded end opposite said outer wall portions.

6. The landscape edging system of claim 4, each said female connector having a joining portion ending in a joint jamb said joining portion being so configured and sized as to slidingly engage at leas ton of said opposed ends of said tubular main body elements.

7. The landscape edging system of claim 6, each said female connector having a female connector reception portion extending axially outward from said male connector joining portion.

8. The landscape edging system of claim 7, each said female connector reception portion comprising an upper joint portion and a lower joint portion, each so sized and spaced as to receive said male connector insert portion.

9. The landscape edging system of claim 8, further comprising a female connector base portion connecting said reception portion and said upper and lower joint portions and thereby defining a receiving groove for receiving said male connector insert portion, said upper and lower joint portions having rounded ends.

10. The landscape edging system of claim 9, said upper and lower joint portions of said female reception portion and said male insert portion defining a continuous stake receiving bore upon insertion of said male insert portion into said female reception portion.

11. The landscape edging system of claim 11, said upper and lower joint portions of said female reception portion and said male insert portion being horizontally disposed relative to said main body element, whereby, upon insertion of said male insert portion of said male connector into said female reception portion of said female connector, said stake may be inserted through said continuous stake receiving bore and into the ground, said connectors and stake acting as a hinge for adjustable mutual rotation of said log units to a desired angle.

12. The landscape edging system of claim 1, further comprising a plurality of three-way joint connectors slidingly and frictionally engaging said tubular main body elements at selected ends thereof, so as to form a joint between three said tubular main body elements by means of joining said male connector with a three-way joint connector in an upper position and a three-way joint connector in a lower position.

13. The landscape edging system of claim 4, further comprising a plurality of three-way joint connectors slidingly and frictionally engaging said tubular main body elements at selected ends thereof, so as to form a joint between three said tubular main body elements by means of joining said male connector with a three-way joint connector in an upper position and a three-way joint connector in a lower position.

14. The landscape edging system of claim 13, each said three-way joint connector comprising a three-way connector joining portion ending in a joint jamb so configured and sized as to slidingly engage said opposed ends of said tubular main body elements.

15. The landscape edging system of claim 14, each said three-way joint connector further comprising a base portion and a three-way joint portion, said base portion having an outer wall and forming said joint jamb and connecting said joint connector and said three-way joint portion.

16. The landscape edging system of claim 15, said three-way joint portion of said three-way joint connector extending axially outward from said outer wall of said base portion at one of an upper position and a lower position and defining a central position for receiving said insert portion of said male connector.

17. The landscape edging system of claim 15, each said upper and said lower three-way joint portion and said male insert portion defining a continuous stake receiving bore for receiving a said stake upon insertion of said male insert portion between said upper an lower three-way joint portions said central position.

18. The landscape edging system of claim 17, said upper and said lower three-way joint portions and said male insert portion being horizontally disposed relative to said main body elements, whereby, upon insertion of said male insert portion of said male connector between said upper and lower three-way joint portion of said three-way connectors, said stake may be inserted through said continuous stake receiving bore and into the ground, said connectors and stake acting as a hinge for adjustable mutual rotation of said log units to a desired angle.

19. The landscape edging system of claim 1, wherein said tubular main body elements and said connector joint portions and said base portions of said connectors form one of a log unit simulating a log and a tie.

20. A landscape edging system, comprising:
a plurality of simulated log units comprising:
a plurality of tubular main body elements having opposing sidewalls, upper and lower walls, and opposing ends;
a plurality of male connectors slidingly and frictionally engaging said tubular main body elements at one respective end thereof;
a plurality of female connectors slidingly and frictionally engaging said tubular main body elements at and opposed respective end thereof.
each said male connector and said female connector defining a stake-receiving bore;
said stake-receiving bores of said female connectors and said male connectors defining a common stake receiving bore upon the mating of said female connectors with said male connectors; and
a plurality of three-way joint connectors slidingly and frictionally engaging said tubular main body elements at selected ends thereof, so as to form a joint between three said tubular main body elements by joining said male connector with a said three-way joint connector in a lower position;
a plurality of stakes of such size and length as to be received in said common stake-receiving bore upon assembly of said simulated log units and driven into the ground;
said plurality of stakes acting as axles around which pairs of said simulated log units may be rotated relative to each other so as to obtain a desired edging pattern.
